(19) United States
(12) Patent Application Publication
(10) Pub. No.: US 2021/0292594 A1
(43) Pub. Date: Sep. 23, 2021

(54) COATING COMPOSITIONS FOR BITUMINOUS MATERIALS

(71) Applicant: SWIMC LLC, Cleveland, OH (US)

(72) Inventors: Brent Crenshaw, Woodstock, IL (US); Allen Bulick, Bolingbrook, IL (US); Glenn Frazee, Twin Lakes, WI (US); Mary Jane Hibben, Elburn, IL (US); Robert Sandoval, Crystal Lake, IL (US)

(73) Assignee: SWIMC LLC, Cleveland, OH (US)

(21) Appl. No.: 17/259,479

(22) PCT Filed: Jul. 12, 2019
(86) PCT No.: PCT/US2019/041643

§ 371 Date: Jan. 11, 2021

Related U.S. Application Data
(60) Provisional application No. 62/697,863, filed on Jul. 13, 2018.

(51) Int. Cl. C09D 133/10; C08L 33/10

(52) U.S. Cl. CPC C09D 133/10; C08L 2201/52; C08L 33/10

(57) ABSTRACT

A latex emulsion may include an aqueous carrier liquid, a first (meth)acrylic copolymer or stage exhibiting a measured glass transition temperature between about −15° C. and about −50° C., and a second (meth)acrylic copolymer or stage exhibiting a measured glass transition temperature between about −10° C. and about 20° C. The first and second (meth)acrylic copolymers or stages may include less than about 20 weight percent styrene, if any, based on the total weight of emulsion polymerized ethylenically unsaturated monomers in the first and second (meth)acrylic copolymers or stages. The latex emulsion may be formulated into an aqueous coating composition and be used as a cool roof coating for bituminous materials, such as bituminous roof materials.

### TECHNICAL FIELD

The disclosure is directed to coating compositions for bituminous materials.

### BACKGROUND

Bituminous materials (also referred to as asphaltic materials) are used as roofing materials for commercial and industrial buildings. While bituminous materials provide good weather resistance, bituminous materials are also generally dark in color and absorb large amounts of solar radiation, increasing cooling requirements for commercial and industrial buildings having a roof or a portion thereof coated with bituminous roofing materials.

### SUMMARY

In some examples, the disclosure describes a latex emulsion including an aqueous carrier liquid, a first (meth)acrylic copolymer or stage exhibiting a measured glass transition temperature between about −60° C. and about −5° C., and a second (meth)acrylic copolymer or stage exhibiting a measured glass transition temperature between about −10° C. and about 30° C. The first and second (meth)acrylic copolymers or stages may include less than about 20 weight percent styrene, if any, based on the total weight of emulsion polymerized ethylenically unsaturated monomers in the first and second (meth)acrylic copolymers or stages; or, one or more gradient emulsion copolymers having a broad measured T_{g}, wherein the one or more gradient emulsion copolymers is a reaction product of a first (meth)acrylic monomer composition which, when polymerized, would provide a (meth)acrylic copolymer having a measured T_{g} of about −60° C. to about −5° C. and a second (meth)acrylic monomer composition which, when polymerized, would provide a copolymer having a measured T_{g} of about −10° C. to about 30° C., wherein relative proportions of the a first (meth)acrylic monomer composition and the second (meth)acrylic monomer composition changes during formation of the one or more gradient emulsion copolymers.

In some examples, the disclosure describes an aqueous coating composition that includes a latex emulsion including an aqueous carrier liquid, a first (meth)acrylic copolymer or stage exhibiting a measured glass transition temperature between about −60° C. and about −5° C., and a second (meth)acrylic copolymer or stage exhibiting a measured glass transition temperature between about −10° C. and about 30° C. The first and second (meth)acrylic copolymers or stages may include less than about 20 weight percent styrene, if any, based on the total weight of emulsion polymerized ethylenically unsaturated monomers in the first and second (meth)acrylic copolymers or stages. The aqueous coating composition preferably also includes a dispersant, a biocide, a fungicide, an UV stabilizer, a thickener, a wetting agent, a defoamer, a filler, or a pigment or colorant, or combinations thereof.

In some examples, the disclosure describes a roofing system that includes a bituminous roofing material and a coating on a surface of the bituminous roofing material. The coating is formed from a latex emulsion that includes an aqueous carrier liquid, a first (meth)acrylic copolymer or stage exhibiting a measured glass transition temperature between about −60° C. and about −5° C., and a second (meth)acrylic copolymer or stage exhibiting a measured glass transition temperature between about −10° C. and about 30° C. The first and second (meth)acrylic copolymers or stages may include less than about 20 weight percent styrene, if any, based on the total weight of emulsion polymerized ethylenically unsaturated monomers in the first and second (meth)acrylic copolymers or stages.

In some examples, the disclosure describes a roofing system that includes a bituminous roofing material and a coating on a surface of the bituminous roofing material. The coating is formed from an aqueous coating composition that includes a latex emulsion including an aqueous carrier liquid, a first (meth)acrylic copolymer or stage exhibiting a measured glass transition temperature between about −60° C. and about −5° C., and a second (meth)acrylic copolymer or stage exhibiting a measured glass transition temperature between about −10° C. and about 30° C. The first and second (meth)acrylic copolymers or stages comprise less than about 15 weight percent styrene, if any, based on the total weight of emulsion polymerized ethylenically unsaturated monomers in the first and second (meth)acrylic copolymers or stages. The aqueous coating composition preferably also includes a dispersant, a biocide, a fungicide, an UV stabilizer, a thickener, a wetting agent, a defoamer, a filler, or a pigment or colorant, or combinations thereof.

In some examples, the disclosure describes a method that includes coating a bituminous roofing material with a coating formed from a latex emulsion that includes an aqueous carrier liquid, a first (meth)acrylic copolymer or stage exhibiting a measured glass transition temperature between about −60° C. and about −5° C., and a second (meth)acrylic copolymer or stage exhibiting a measured glass transition temperature between about −10° C. and about 30° C. The first and second (meth)acrylic copolymers or stages may include less than about 20 weight percent styrene, if any, based on the total weight of emulsion polymerized ethylenically unsaturated monomers in the first and second (meth)acrylic copolymers or stages.

In some examples, the disclosure describes a method that includes coating a bituminous roofing material with a coating formed from an aqueous coating composition that includes a latex emulsion including an aqueous carrier liquid, a first (meth)acrylic copolymer or stage exhibiting a measured glass transition temperature between about −60° C. and about −5° C., and a second (meth)acrylic copolymer or stage exhibiting a measured glass transition temperature between about −10° C. and about 30° C. The first and second (meth)acrylic copolymers or stages may include less than about 20 weight percent styrene, if any, based on the total weight of emulsion polymerized ethylenically unsaturated monomers in the first and second (meth)acrylic copolymers or stages. The aqueous coating composition preferably also includes a dispersant, a biocide, a fungicide, an UV stabilizer, a thickener, a wetting agent, a defoamer, a filler, or a pigment or colorant, or combinations thereof.

In another aspect, the present disclosure is directed to a process for producing a latex emulsion, including: reacting in an aqueous carrier liquid a first (meth)acrylic copolymer or stage exhibiting a measured glass transition temperature of about −60° C. to about −5° C.; and a second (meth)acrylic copolymer or stage exhibiting a measured glass transition temperature of about −10° C. to about 30° C.; wherein the first and second (meth)acrylic copolymers or stages comprise less than about 20 weight percent styrene, if any, based on the total weight of emulsion polymerized ethylenically unsaturated monomers in the first and second (meth)acrylic copolymers or stages.

In another aspect, the present disclosure is directed to a process for producing a latex emulsion, including: introducing at least one primary polymerizable feed composition comprising a first (meth)acrylic copolymer exhibiting a measured glass transition temperature of about −60° C. to about −5° C. from at least one primary feed source to a polymerization zone, said primary polymerizable feed composition continually varying in compositional content of the polymerizable reactants therein during said continuous introduction; simultaneously adding to said primary feed source at least one different secondary polymerizable feed composition comprising a second (meth)acrylic copolymer or stage exhibiting a measured glass transition temperature of about −10° C. to about 30° C. from at least one secondary feed source so as to continually change the compositional content of the polymerizable reactants of said primary polymerizable feed composition in said primary feed source; and continuously polymerizing the primary polymerizable feed composition introduced to the polymerization zone until desired polymerization has been achieved.

In another aspect, the present disclosure is directed to a latex emulsion, including: one or more gradient emulsion copolymers having a broad measured T_{g}, wherein the one or more gradient emulsion copolymers are the copolymerization product residue of: a first (meth)acrylic monomer composition which, when polymerized, would provide a copolymer having a measured T_{g} of about −60° C. to about −5° C.; and a second (meth)acrylic monomer composition which, when polymerized, would provide a copolymer having a measured T_{g} of about −10° C. to about 30° C.

In another aspect, the present disclosure is directed to a latex emulsion, including: one or more gradient emulsion copolymers having a broad measured T_{g}, wherein the one or more gradient emulsion copolymers are produced by a process including: continuously introducing into a polymerization zone at least one primary polymerizable feed composition from at least one primary feed source, wherein the primary polymerizable feed composition includes a first (meth)acrylic monomer composition which, when polymerized, would provide a copolymer having a measured T_{g} of about −60° C. to about −5° C., and wherein the compositional content of the first (meth)acrylic monomers in the primary polymerizable feed composition continually varies during the continuous introduction; simultaneously adding to said primary feed source a second polymerizable feed composition from at least one secondary feed source to continually change the compositional content of the polymerizable monomers in said primary polymerizable feed composition from said primary feed source, wherein the second polymerizable feed composition includes a second (meth)acrylic monomer composition which, when polymerized, would provide a copolymer having a measured T_{g} of about −10° C. to about 30° C.; and continuously polymerizing the primary polymerizable feed composition introduced to the polymerization zone until the desired polymerization has been achieved to form the latex emulsion.

The above summary of the present disclosure is not intended to describe each disclosed example or every implementation of the present disclosure. The description that follows more particularly exemplifies illustrative examples. In several places throughout the application, guidance is provided through lists of examples, which can be used in various combinations. In each instance, the recited list serves only as a representative group and should not be interpreted as an exclusive list.

The details of one or more examples are set forth in the description below. Other features, objects, and advantages of the disclosure will be apparent from the description and from the claims.

### DETAILED DESCRIPTION

A “latex” polymer means a dispersion or emulsion of polymer particles formed in the presence of water and one or more dispersing or emulsifying agents (e.g., a surfactant, water-soluble or dispersible polymer, or mixtures thereof). The dispersing or emulsifying agent is typically separate from the polymer after polymer formation. In some examples, a reactive dispersing or emulsifying agent may become part of the polymer particles as they are formed.

The recitation of a numerical range using endpoints includes all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

The terms “preferred” and “preferably” refer to examples of the invention that may afford certain benefits, under certain circumstances. However, other examples may also be preferred, under the same or other circumstances. Furthermore, the recitation of one or more preferred examples does not imply that other examples are not useful, and is not intended to exclude other examples from the scope of the disclosure.

The terms “a,” “an,” “the,” “at least one,” and “one or more” are used interchangeably. Thus, for example, a coating composition that contains “an” additive means that the coating composition includes “one or more” additives.

The phrase “low VOC” when used with respect to a liquid coating composition means that the liquid coating composition contains less than about 150 g/L (about 15% w/v), preferably not more than about 100 g/L (about 10% w/v), more preferably not more than about 50 g/L (about 5% w/v), and most preferably less than 20 g/L (about 2% w/v), for example not more than about 10 g/L (about 1% w/v) or not more than about 8 g/L (about 0.8% w/v) volatile organic compounds.

The term “(meth)acrylic acid” includes either or both of acrylic acid and methacrylic acid, and the term “(meth)acrylate” includes either or both of an acrylate and a methacrylate. Similarly, the term “(meth)acrylic” include either or both of an acrylic or a methacrylic polymer, i.e., a polymer that incorporates acrylic or methacrylic monomers.

The term “multistage” when used with respect to a latex means the latex polymer was made using discrete charges of one or more monomers or was made using a continuously-varied charge of two or more monomers. Usually a multistage latex will not exhibit a single T_{g} inflection point as measured using differential scanning colorimetry (“DSC”). For example, a DSC curve for a multistage latex made using discrete charges of one or more monomers may exhibit two or more T_{g} inflection points. Also, a DSC curve for a multistage latex made using a continuously-varied charge of two or more monomers may exhibit no T_{g} inflection points. By way of further explanation, a DSC curve for a single stage latex made using a single monomer charge or a non-varying charge of two monomers may exhibit only a single T_{g} inflection point. Occasionally when only one T_{g} inflection point is observed, it may be difficult to determine whether the latex represents a multistage latex. In such cases a lower T_{g} inflection point may sometimes be detected on closer inspection, or the synthetic scheme used to make the latex may be examined to determine whether or not a multistage latex would be expected to be produced.

The terms “topcoat” or “final topcoat” refer to a coating composition which when dried or otherwise hardened provides a decorative or protective outermost finish layer on a substrate, for example, a polymeric membrane attached to a building exterior (e.g., a roof). By way of further explanation, such final topcoats include paints, stains or sealers capable of withstanding extended outdoor exposure (e.g., exposure equivalent to one year of vertical south-facing Florida sunlight) without visually objectionable deterioration, but do not include primers that would not withstand extended outdoor exposure if left uncoated with a topcoat.

The present disclosure describes latex emulsions and aqueous coating compositions including latex emulsions that may be used as coatings for bituminous roofing materials. The latex emulsions and aqueous coating compositions may reduce or substantially block migration of constituents from the bituminous roofing material into and/or through the coating to reduce or substantially eliminate discoloration (e.g., darkening) of the coating over time. The coating also may maintain flexibility to a temperature of at least as low as −30° C., which may reduce or substantially prevent cracking of the coating when used on bituminous roofing materials.

The coating may be used as a “cool” roof coating. Cool roof coatings are typically white or light colored. Cool roof coatings are applied to roofs to reduce absorption of solar radiation, ultimately reducing overall energy demand for cooling the building. Many commercial and industrial roofs are coated with bituminous materials, which have solar reflective indices (SRIs) of less than about 0.2. Cool roof coatings may have SRIs of greater than about 0.7. Many conventional cool roof coating systems use a combination of one of an intermediate, a tie, a primer, or a binder coating, and a topcoat.

The binder system in a conventional cool roof coating system may be based on poly(acrylic) or silicone polymers. The binder system generally must exhibit coating flexibility at −26° C. per ASTM D6083 to meet municipality performance requirements. However, conventional binder systems that exhibit sufficient flexibility generally exhibit significant surface discoloration (e.g., yellowing) over time due to bleed through of constituents of the bituminous materials. For example, ΔE color shifts of greater than 25 may occur. Such color shifts may cause the binder system to appear yellow, orange, or brown depending on the polymer and the extent of the color shift.

To combat this color shift in conventional cool roof coating systems, the coating system may use a less flexible, bleed blocking basecoat and a more flexible topcoat. However, such coating system increases complexity, cost, and application time.

In accordance with examples of this disclosure, a latex emulsion and aqueous coating composition may provide a cool roof coating for application over bituminous materials. In some examples, the latex emulsion and aqueous coating composition may be applied directly to the bituminous material as a single-layer coating that exhibits both sufficient low temperature flexibility (e.g., flexibility to a temperature of at least −30° C.) and reduced or substantially no discoloration due to leaching of constituents of the bituminous material into and/or through the coating over time.

The latex emulsion and aqueous coating composition may include a mixture of two emulsion polymerized (meth)acrylic copolymers or a multi-stage emulsion polymerized (meth)acrylic copolymer.

A first (meth)acrylic copolymer or a first stage of the multi-stage (meth)acrylic copolymer may be formed from (meth)acrylic monomers that result in the first (meth)acrylic copolymer or a first stage of the multi-stage (meth)acrylic copolymer exhibiting a measured glass transition temperature (T_{g}) of between about −60° C. and about −5° C., or about −50° C. and about −10° C., or about −25° C. and −15° C. The first (meth)acrylic copolymer or stage may be referred to as a lower T_{g} (meth)acrylic copolymer or stage.

A second (meth)acrylic copolymer or a second stage of the multi-stage (meth)acrylic copolymer may be formed from (meth)acrylic monomers that result in the second (meth)acrylic copolymer or a second stage of the multi-stage (meth)acrylic copolymer exhibiting a measured T_{g} of between about −10° C. and about 30° C., or about 0° C. and about 20° C., or about 0° C. and about 10° C. The second (meth)acrylic copolymer or stage may be referred to as a higher T_{g} (meth)acrylic copolymer or stage.

In some examples, the difference between the measured glass transition temperature of the first (meth)acrylic copolymer or a first stage of the multi-stage (meth)acrylic copolymer and the measured glass transition temperature of the second (meth)acrylic copolymer or the second stage of the multi-stage (meth)acrylic copolymer is at least 15° C.

The latex emulsion may include an aqueous carrier, the lower T_{g} (meth)acrylic copolymer or stage, the higher T_{g} (meth)acrylic copolymer or stage, and, optionally, one or more emulsifiers for stabilizing the emulsion.

The lower T_{g} (meth)acrylic copolymer or stage may be formed using emulsion polymerization. The reactants from which the first (meth)acrylic copolymer or stage is formed may include monomers and other components that may or may not be incorporated in the first (meth)acrylic copolymer or stage, such as a chain transfer agent, a free radical initiator or redox agent, a seed latex, or the like, and combinations thereof. In some examples, the reactants from which the first (meth)acrylic copolymer or stage is formed may include at least one (meth)acrylate monomer, and, optionally, one or more of an ethylenically unsaturated polar monomer component, a ureido-functional monomer component, a chain transfer agent, and the like.

The at least one (meth)acrylate monomer for the lower T_{g} (meth)acrylic copolymer or stage may be selected to achieve the desired T_{g} for the lower T_{g} (meth)acrylic copolymer or stage. In some examples, a combination of two or more (meth)acrylate monomers may be used to form a substantially random copolymer having the desired T_{g}. Suitable (meth)acrylate monomers include, but are not limited to, methyl acrylate, ethyl acrylate, propyl acrylate, butyl acrylate, 2-ethylhexyl acrylate, methyl methacrylate, ethyl methacrylate, propyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAEM), or the like, and combinations thereof.

In some examples, the lower T_{g} (meth)acrylic copolymer or stage may include at least one other monomer that includes a vinyl group, such as, for example, diacetone acrylamide (DAAM), acrylamide, methacrylamide, methylol (meth)acrylamide, styrene, α-methyl styrene, vinyl toluene, vinyl acetate, vinyl propionate, allyl methacrylate, and combinations thereof.

In some examples, the lower T_{g} (meth)acrylic copolymer or stage may include significant amounts of at least one of butyl acrylate, 2-ethylhexylacrylate, or combinations thereof. Butyl acrylate and 2-ethylhexylacrylate are monomers that tend to produce relatively soft (i.e., low T_{g}) homopolymers, and thus tend to reduce a T_{g} of a copolymer of which they are part. Butyl acrylate, 2-ethylhexylacrylate, or both may be combined with one or more other monomers having a higher homopolymer T_{g} to achieve a desired T_{g} for the first (meth)acrylic copolymer or stage. For example, butyl acrylate, 2-ethylhexylacrylate, or both may be combined with one or more of methyl methacrylate, styrene, butyl methacrylate, methacrylic acid, or the like, in selected proportions to achieve a targeted T_{g}. The proportions may be determined experimentally (e.g., by reacting various ratios of monomers then measuring the T_{g} of the resultant copolymer), theoretically (e.g., using the Fox equation), or a combination of theoretical calculation and experimental verification. In some examples, the lower T_{g} (meth)acrylic copolymer or stage may be formed from monomers including at least 40 weight percent butyl acrylate, 2-ethylhexylacrylate, or combinations thereof; monomers including at least 50 weight percent butyl acrylate, 2-ethylhexylacrylate, or combinations thereof; monomers including at least 60 weight percent butyl acrylate, 2-ethylhexylacrylate, or combinations thereof; monomers including at least 70 weight percent butyl acrylate, 2-ethylhexylacrylate, or combinations thereof; or monomers including at least 75 weight percent butyl acrylate, 2-ethylhexylacrylate, or combinations thereof; each based on a total weight of emulsion polymerized ethylenically unsaturated monomers in the lower T_{g} (meth)acrylic copolymer or stage.

The monomers from which the lower T_{g} (meth)acrylic copolymer or stage is formed also may include an ethylenically unsaturated polar monomer. For example, the ethylenically unsaturated polar may include an ethylenically unsaturated monomer including at least one alcohol group, an ethylenically unsaturated monomer including at least one acid group, an ethylenically unsaturated ionic monomer, an at least partially neutralized ethylenically unsaturated acid group or base group containing monomer, an anhydride-functional ethylenically unsaturated monomer, an at least partially neutralized or anhydride-functional ethylenically unsaturated monomer, or the like, and combinations thereof. The at least partially neutralized ethylenically unsaturated acid group or base group containing monomer may be a salt form of the ethylenically unsaturated acid group or base group containing monomer, and the salt form may be formed prior to, during, or after reaction of the ethylenically unsaturated acid group or base group containing monomer with the other monomers in the reactants used to form the lower T_{g} (meth)acrylic copolymer or stage. In some examples, the ethylenically unsaturated ionic monomer component may include acrylic acid, methacrylic acid, crotonic acid, fumaric acid, maleic acid, 2-methyl maleic acid, itaconic acid, 2-methyl itaconic acid, anhydride variants thereof, at least partially neutralized variants thereof, or the like, or combinations thereof.

The monomers used to form the lower T_{g} (meth)acrylic copolymer or stage may include at least about 0.1 weight percent of the ethylenically unsaturated polar monomer component, based on the total weight of emulsion polymerized ethylenically unsaturated monomers used to form the lower T_{g} (meth)acrylic copolymer or stage; or greater than about 0.5 weight percent of the ethylenically unsaturated polar monomer component, based on the total weight of emulsion polymerized ethylenically unsaturated monomers used to form the lower T_{g} (meth)acrylic copolymer or stage; or greater than about 1 weight percent of the ethylenically unsaturated polar monomer component, based on the total weight of emulsion polymerized ethylenically unsaturated monomers used to form the lower T_{g} (meth)acrylic copolymer or stage. In some examples, the monomers include less than about 10 weight percent of the ethylenically unsaturated polar monomer component, based on the total weight of emulsion polymerized ethylenically unsaturated monomers used to form the lower T_{g} (meth)acrylic copolymer or stage; or less than about 5 weight percent of the ethylenically unsaturated polar monomer component, based on the total weight of emulsion polymerized ethylenically unsaturated monomers used to form the lower T_{g} (meth)acrylic copolymer or stage; or less than about 3 weight percent of the ethylenically unsaturated polar monomer component, based on the total weight of emulsion polymerized ethylenically unsaturated monomers used to form the lower T_{g} (meth)acrylic copolymer or stage

The reactants used to form the lower T_{g} (meth)acrylic copolymer or stage also may include a chain transfer agent. In some examples, the reactants include at least about 0.1 weight percent of the chain transfer agent, based on the total weight of emulsion polymerized ethylenically unsaturated monomers used to form the lower T_{g} (meth)acrylic copolymer or stage; or at least about 0.25 weight percent of the chain transfer agent, based on the total weight of emulsion polymerized ethylenically unsaturated monomers used to form the lower T_{g} (meth)acrylic copolymer or stage; or at least about 0.5 weight percent of the chain transfer agent, based on the total weight of emulsion polymerized ethylenically unsaturated monomers used to form the lower T_{g} (meth)acrylic copolymer or stage. In some examples, the reactants may include less than about 2 weight percent of the chain transfer agent, based on the total weight of emulsion polymerized ethylenically unsaturated monomers used to form the lower T_{g} (meth)acrylic copolymer or stage; or less than about 1 weight percent of the chain transfer agent, based on the total weight of emulsion polymerized ethylenically unsaturated monomers used to form the lower T_{g} (meth)acrylic copolymer or stage; or less than about 0.75 weight percent of the chain transfer agent, based on the total weight of emulsion polymerized ethylenically unsaturated monomers in the lower T_{g} (meth)acrylic copolymer or stage. As relatively low amounts of chain transfer agent are used, the weight percent chain transfer agent is based on emulsion polymerized ethylenically unsaturated monomers, rather than emulsion polymerized ethylenically unsaturated monomers plus chain transfer agent. The chain transfer agent may include any suitable chain transfer agent, such as a thiol. In some examples, the chain transfer agent includes or consists of a mercaptan, such as dodecyl mercaptan.

In some examples, the monomers used to form the lower T_{g} (meth)acrylic copolymer or stage further include a ureido-functional monomer. The ureido-functional monomer may affect adhesion of the lower T_{g} (meth)acrylic copolymer to certain substrates, including polymeric roofing membrane substrates. In some examples, the ureido-functional monomer includes a ureido-functional ethylenically unsaturated monomer, such as a ureido-functional methacrylic monomer.

In some examples, the reactants used to form the lower T_{g} (meth)acrylic copolymer or stage further include a seed latex. The seed latex may function as a polymerization growth site and may affect a final particle size of the lower T_{g} (meth)acrylic copolymer or stage.

The lower T_{g} (meth)acrylic copolymer or stage may optionally include relatively small amounts of components that may adversely affect the blocking function of the coating. For example, inclusion of styrene monomers in the lower T_{g} (meth)acrylic copolymer or stage in amounts above a threshold value may reduce an effectiveness of the coating in blocking bleed-through of constituents of the bituminous substrate on which the coating is applied. While not wishing to be bound by theory, this may be due to affinity between the benzene ring in the styrene monomer and constituents of the bituminous substrate. In some examples, the monomers used to form the lower T_{g} (meth)acrylic copolymer or stage may include less than about 20 weight percent styrene, if any, based on the total weight of emulsion polymerized ethylenically unsaturated monomers in the lower T_{g} (meth)acrylic copolymer or stage. In other examples, the monomers used to form the lower T_{g} (meth)acrylic copolymer or stage may include less than about 15 weight percent styrene, if any; less than about 10 weight percent styrene, if any; less than about 9 weight percent styrene, if any; less than about 8 weight percent styrene, if any; less than about 7 weight percent styrene, if any; less than about 6 weight percent styrene, if any; less than about 5 weight percent styrene, if any; less than about 4 weight percent styrene, if any; less than about 3 weight percent styrene, if any; less than about 2 weight percent styrene, if any; less than about 1 weight percent styrene, if any; or essentially no styrene.

The lower T_{g} (meth)acrylic copolymers disclosed above may, in some examples, be formed and/or stabilized with one or more emulsifiers (e.g., surfactants), used either alone or together. Such surfactants may be polymeric, non-polymeric, or a mixture thereof. Such surfactants may also optionally include one or more ethylenically unsaturated groups to facilitate incorporation of at least some of the surfactant, via covalent attachment, into the latex polymer. The surfactants may be non-ionic, ionic, or a mixture thereof. Examples of suitable nonionic emulsifiers include, but are not limited to, tert-octylphenoxyethylpoly(39)-ethoxyethanol, dodecyloxypoly(10)ethoxyethanol, nonylphenoxyethyl-poly(40)ethoxyethanol, polyethylene glycol 2000 monooleate, ethoxylated castor oil, fluorinated alkyl esters and alkoxylates, polyoxyethylene (20) sorbitan monolaurate, sucrose monococoate, di(2-butyl) phenoxypoly(20)ethoxyethanol, hydroxyethylcellulosepolybutyl acrylate graft copolymer, dimethyl silicone polyalkylene oxide graft copolymer, poly(ethylene oxide)poly(butyl acrylate) block copolymer, block copolymers of propylene oxide and ethylene oxide, 2,4,7,9-tetramethyl-5-decyne-4,7-diol ethoxylated with ethylene oxide, N-polyoxyethylene(20)lauramide, N-lauryl-N-polyoxyethylene(3)amine and poly(10)ethylene glycol dodecyl thioether. Examples of suitable anionic emulsifiers include sodium lauryl sulfate, sodium dodecylbenzenesulfonate, potassium stearate, sodium dioctyl sulfosuccinate, sodium dodecyldiphenyloxide disulfonate, nonylphenoxyethylpoly(1)ethoxyethyl sulfate ammonium salt, sodium styrene sulfonate, sodium dodecyl allyl sulfosuccinate, linseed oil fatty acid, sodium, potassium, or ammonium salts of phosphate esters of ethoxylated nonylphenol or tridecyl alcohol, sodium octoxynol-3-sulfonate, sodium cocoyl sarcocinate, sodium 1-alkoxy-2-hydroxypropyl sulfonate, sodium alpha-olefin (C₁₄-C₁₆)sulfonate, sulfates of hydroxyalkanols, tetrasodium N-(1,2-dicarboxy ethyl)-N-octadecylsulfosuccinamate, disodium N-octadecylsulfosuccinamate, disodium alkylamido poly-ethoxy sulfosuccinate, disodium ethoxylated nonylphenol half ester of sulfosuccinic acid and the sodium salt of tert-octylphenoxyethoxypoly(39)ethoxyethyl sulfate.

The lower T_{g} (meth)acrylic copolymer or stage may be polymerized using chain growth polymerization. One or more water-soluble free radical initiators may be used in the chain growth polymerization. Initiators suitable for use in the coating compositions will be known to persons having ordinary skill in the art or can be determined using standard methods. Representative water-soluble free radical initiators include hydrogen peroxide; tert-butyl peroxide; alkali metal persulfates such as sodium, potassium and lithium persulfate; ammonium persulfate; and mixtures of such initiators with a reducing agent. Representative reducing agents include sulfites such as alkali metal metabisulfite, hydrosulfite, and hyposulfite; sodium formaldehyde sulfoxylate; and reducing sugars such as ascorbic acid and isoascorbic acid. The amount of initiator is preferably from about 0.01 weight % to about 3 weight %, based on the total weight of emulsion polymerized ethylenically unsaturated monomers used to form the lower T_{g} (meth)acrylic copolymer or stage. In a redox system the amount of reducing agent is preferably from 0.01 to 3 weight percent, based on the total weight of emulsion polymerized ethylenically unsaturated monomers used to form the lower T_{g} (meth)acrylic copolymer or stage. As a relatively low amount of free radical initiator is used, the weight percent free radical initiator is based on emulsion polymerized ethylenically unsaturated monomers, rather than emulsion polymerized ethylenically unsaturated monomers plus free radical initiator. The polymerization reaction can be performed at a temperature in the range of from about 10° C. to about 100° C.

The lower T_{g} (meth)acrylic copolymer may exhibit a measured glass transition temperature of less than about −5° C., or less than about −10° C., or less than about −15° C. In some examples, the lower T_{g} (meth)acrylic copolymer exhibits a measured glass transition temperature of greater than about −60° C., or greater than about −60° C., or greater than about −25° C. For example, the lower T_{g} (meth)acrylic copolymer may exhibit a measured glass transition temperature of between about −60° C. and about −5° C., or between about −25° C. and about −15° C. The glass transition temperature may be measured by air drying a sample overnight and analyzing the dried sample on a Q2000 DSC from TA Instruments using a heat-cool-heat cycle from −75° C. to 150° C. at a rate of 20° C. per minute. The glass transition temperature may be measured from the midpoint of the transition on the second heat cycle.

The lower T_{g} (meth)acrylic copolymer may exhibit any suitable volume average particle size, as the average particle size is not believed to be particularly important. In some examples, the lower T_{g} (meth)acrylic copolymer may exhibit any volume average particle size of between about 150 nm and about 550 nm. The volume average particle size may be determined using a Nanotrac Wave II particle size analyzer from Microtrac Inc., Montgomeryville, Pa.

The latex emulsion may include a combination (e.g., mechanical mixture) of the lower T_{g} (meth)acrylic copolymer (described above) and a second, higher T_{g} (meth)acrylic copolymer, or may include a multi-stage (meth)acrylic copolymer (e.g., a multi-stage latex) including a lower T_{g} stage that is the lower T_{g} (meth)acrylic copolymer described above and a second, higher T_{g} stage. The second, higher T_{g} (meth)acrylic copolymer may exhibit a T_{g} of between about −20° C. and about 20° C.

The higher T_{g} (meth)acrylic copolymer or stage may be formed using emulsion polymerization. Typically, both the lower T_{g} (meth)acrylic copolymer or stage and the higher T_{g} (meth)acrylic copolymer or stage are formed using emulsion polymerization. The reactants from which the higher T_{g} (meth)acrylic copolymer or stage is formed may include monomers and other components that may or may not be incorporated in the higher T_{g} (meth)acrylic copolymer or stage, such as a chain transfer agent, a free radical initiator or redox agent, a seed latex, or the like, and combinations thereof. The reactants from which the higher T_{g} (meth)acrylic copolymer or stage is formed may include at least one (meth)acrylate monomer, and, optionally, one or more of an ethylenically unsaturated polar monomer component, a ureido-functional monomer component, a chain transfer agent, and the like.

The at least one (meth)acrylate monomer for the higher T_{g} (meth)acrylic copolymer or stage may be selected to achieve the desired T_{g} for the higher T_{g} (meth)acrylic copolymer or stage. In some examples, a combination of two or more (meth)acrylate monomers may be used to form a substantially random copolymer having the desired T_{g}. Suitable (meth)acrylate monomers include methyl acrylate, ethyl acrylate, propyl acrylate, butyl acrylate, 2-ethylhexyl acrylate, methyl methacrylate, ethyl methacrylate, propyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAEM), or the like.

In some examples, the higher T_{g} (meth)acrylic copolymer or stage may include at least one other monomer that includes a vinyl group, such as, for example, diacetone acrylamide (DAAM), acrylamide, methacrylamide, methylol (meth)acrylamide, styrene, α-methyl styrene, vinyl toluene, vinyl acetate, vinyl propionate, allyl methacrylate, and mixtures thereof.

In some examples, the higher T_{g} (meth)acrylic copolymer or stage may include significant amounts of at least one of methyl methacrylate, styrene, butyl methacrylate, methacrylic acid, or combinations thereof. Methyl methacrylate, styrene, butyl methacrylate, methacrylic acid are monomers that tend to produce relatively hard (i.e., high T_{g}) homopolymers, and thus tend to increase a T_{g} of a copolymer of which they are part. Methyl methacrylate, styrene, butyl methacrylate, methacrylic acid, or combinations thereof may be combined with other monomers having a lower homopolymer T_{g} to achieve a desired T_{g} for the higher T_{g} (meth)acrylic copolymer or stage. For example, methyl methacrylate, styrene, butyl methacrylate, methacrylic acid, or combinations thereof may be combined with butyl acrylate, 2-ethylhexylacrylate, or the like, in selected proportions to achieve a targeted T_{g}. The proportions may be determined experimentally (e.g., by reacting various ratios of monomers then measuring the T_{g} of the resultant copolymer), theoretically (e.g., using the Fox equation), or a combination of theoretical calculation and experimental verification. In some examples, the higher T_{g} (meth)acrylic copolymer or stage may be formed from monomers including at least 40 weight percent methyl methacrylate, styrene, butyl methacrylate, methacrylic acid, or combinations thereof monomers including at least 50 weight percent methyl methacrylate, styrene, butyl methacrylate, methacrylic acid, or combinations thereof or monomers including at least 60 weight percent methyl methacrylate, styrene, butyl methacrylate, methacrylic acid, or combinations thereof.

The monomers from which the higher T_{g} (meth)acrylic copolymer or stage is formed also may include an ethylenically unsaturated polar monomer. The ethylenically unsaturated polar monomer may include any one or more of the ethylenically unsaturated polar monomers described above with reference to the lower T_{g} (meth)acrylic copolymer or stage. Similar or substantially the same amounts of ethylenically unsaturated polar monomer(s) may be used to form the higher T_{g} (meth)acrylic copolymer or stage as described above with reference to the lower T_{g} (meth)acrylic copolymer or stage.

The reactants used to form the higher T_{g} (meth)acrylic copolymer or stage also may include a chain transfer agent. The identity of the chain transfer agent and the amount of chain transfer agent used in the reaction mixture may be similar to or substantially the same as described above with reference to the lower T_{g} (meth)acrylic copolymer or stage.

In some examples, the monomers used to form the higher T_{g} (meth)acrylic copolymer or stage further include a ureido-functional monomer. The ureido-functional monomer may affect adhesion of the higher T_{g} (meth)acrylic copolymer to certain substrates, including polymeric roofing membrane substrates. In some examples, the ureido-functional monomer includes a ureido-functional ethylenically unsaturated monomer, such as a ureido-functional methacrylic monomer.

In some examples, the reactants used to form the higher T_{g} (meth)acrylic copolymer or stage further include a seed latex. The seed latex may function as a polymerization growth site and may affect a final particle size of the higher T_{g} (meth)acrylic copolymer or stage.

The higher T_{g} (meth)acrylic copolymer or stage may optionally include relatively small amounts of components that may adversely affect the blocking function of the coating. For example, inclusion of styrene monomers in the higher T_{g} (meth)acrylic copolymer or stage in amounts above a threshold value may reduce an effectiveness of the coating in blocking bleed-through of constituents of the bituminous substrate on which the coating is applied. While not wishing to be bound by theory, this may be due to affinity between the benzene ring in the styrene monomer and constituents of the bituminous substrate. In some examples, the monomers used to form the higher T_{g} (meth)acrylic copolymer or stage may include less than about 20 weight percent styrene, if any, based on the total weight of emulsion polymerized ethylenically unsaturated monomers used to form the higher T_{g} (meth)acrylic copolymer or stage. In other examples, the monomers used to form the higher T_{g} (meth)acrylic copolymer or stage may include than about 15 weight percent styrene, if any; less than about 10 weight percent styrene, if any; less than about 9 weight percent styrene, if any; less than about 8 weight percent styrene, if any; less than about 7 weight percent styrene, if any; less than about 6 weight percent styrene, if any; less than about 5 weight percent styrene, if any; less than about 4 weight percent styrene, if any; less than about 3 weight percent styrene, if any; less than about 2 weight percent styrene, if any; less than about 1 weight percent styrene, if any; or essentially no styrene.

The higher T_{g} (meth)acrylic copolymers disclosed above may, in some examples, be formed and/or stabilized with one or more emulsifiers (e.g., surfactants), used either alone or together. Such emulsifiers (e.g., surfactants) may be selected from compounds similar to or substantially the same as those described above with respect to the lower T_{g} (meth)acrylic copolymer or stage.

The higher T_{g} (meth)acrylic copolymer or stage may be polymerized using chain growth polymerization. One or more water-soluble free radical initiators may be used in the chain growth polymerization. Initiators suitable for use in the coating compositions will be known to persons having ordinary skill in the art or can be determined using standard methods, and may be selected from compounds similar to or substantially the same as those described above with respect to the lower T_{g} (meth)acrylic copolymer or stage. The polymerization reaction can be performed at a temperature in the range of from about 10° C. to about 100° C.

The higher T_{g} (meth)acrylic copolymer may exhibit any suitable volume average particle size, as the average particle size is not believed to be particularly important. In some examples, the higher T_{g} (meth)acrylic copolymer may exhibit any volume average particle size of between about 150 nm and about 550 nm. The volume average particle size may be determined using a Nanotrac Wave II particle size analyzer from Microtrac Inc., Montgomeryville, Pa.

In examples in which a multi-stage (meth)acrylic polymer is formed, the higher T_{g} stage and lower Tg stage may be formed in any order (e.g., the higher T_{g} first followed by the lower T_{g} stage, or vice versa). Further, rather than including a single higher T_{g} (meth)acrylic copolymer or stage and a single lower T_{g} (meth)acrylic copolymer or stage, the latex emulsion may include two or more higher T_{g} (meth)acrylic copolymers or stages and a single lower T_{g} (meth)acrylic copolymer or stage, two or more lower T_{g} (meth)acrylic copolymers or stages and a single higher T_{g} (meth)acrylic copolymer or stage, or two or more lower T_{g} (meth)acrylic copolymers or stages and two or more higher T_{g} (meth)acrylic copolymers or stages.

The higher T_{g} (meth)acrylic copolymer may exhibit a measured glass transition temperature of greater than about −10° C., or greater than about 0° C. In some examples, the higher T_{g} (meth)acrylic copolymer exhibits a measured glass transition temperature of less than about 30° C., or less than about 20° C., or less than about 10° C. For example, the higher T_{g} (meth)acrylic copolymer may exhibit a measured glass transition temperature of between about −10° C. and about 30° C., or between about 0° C. and about 20° C., or about 0° C. and about 10° C. The glass transition temperature may be measured by air drying a sample overnight and analyzing the dried sample on a Q2000 DSC from TA Instruments using a heat-cool-heat cycle from −75° C. to 150° C. at a rate of 20° C. per minute. The glass transition temperature may be measured from the midpoint of the transition on the second heat cycle.

In some examples, the T_{g} of the lower T_{g} (meth)acrylic copolymer or stage may be different than the T_{g} of the higher T_{g} (meth)acrylic copolymer by more than a threshold value. For example, the T_{g} of the lower T_{g} (meth)acrylic copolymer or stage may be less than the T_{g} of the higher T_{g} (meth)acrylic copolymer by at least 15° C., or by at least 20° C., or by at least 25° C.

The latex emulsion may include between about 40 weight percent and about 75 weight percent of the lower T_{g} (meth)acrylic copolymer or stage and between about 25 weight percent and about 60 weight percent of the higher T_{g} (meth)acrylic copolymer or stage, based on a total weight of (meth)acrylic copolymers or stages in the latex emulsion. In some examples, the latex emulsion may include between about 40 weight percent and about 60 weight percent of the lower T_{g} (meth)acrylic copolymer or stage and between about 40 weight percent and about 60 weight percent of the higher T_{g} (meth)acrylic copolymer or stage, based on a total weight of (meth)acrylic copolymers or stages in the latex emulsion. In some other examples, the latex emulsion may include between about 45 weight percent and about 55 weight percent of the lower T_{g} (meth)acrylic copolymer or stage and between about 45 weight percent and about 55 weight percent of the higher T_{g} (meth)acrylic copolymer or stage, based on a total weight of (meth)acrylic copolymers or stages in the latex emulsion.

The latex emulsion, as well as the final coating composition, may include a total solids content of between about 40 weight percent and about 75 weight percent, such as between 45 weight percent and about 65 weight percent, or between about 50 weight percent and about 60 weight percent, or about 55 weight percent. In some examples, the lower T_{g} and higher T_{g} (meth)acrylic copolymers or stages may constitute a majority of the total resin solids in the latex emulsion. For example, the combined weight of the lower T_{g} (meth)acrylic copolymer or stage and the higher T_{g} (meth)acrylic copolymer or stage may constitute at least 70 weight percent of the total resin solids in the latex emulsion, or at least 80 weight percent of the total resin solids in the latex emulsion, or at least 90 weight percent of the total resin solids in the latex emulsion.

The latex emulsion may exhibit a viscosity suitable for application of the latex emulsion, either alone or in combination with one or more additives in a coating composition, to a substrate using typical coating application techniques, such as rolling, brushing, dipping, spraying, or the like.

The emulsion polymerization including the lower T_{g} (meth)acrylic copolymer or stage and the higher T_{g} (meth)acrylic copolymer or stage can be carried out either as a batch process or in the form of a feed process, including staged or gradient.

In some embodiments, the feed process includes forced gradient polymerization, which the monomer composition of the feed is varied (e.g., continuously or step-wise) throughout the reaction time as the reaction proceeds. The successive monomer charges are polymerized onto, or in the presence of, a preformed latex prepared by the polymerization of one or more prior monomer charges or stages. The so-called power feed emulsion polymerization process is an example of a procedure which can be used to produce gradient copolymer latex particles, in which the copolymer composition varies in a controlled manner from the center of the particle to its surface.

For example, in power feed emulsion polymerization, latex polymers having a gradient polymeric morphology are prepared by continuously introducing a primary polymerizable feed composition from a primary feed source to a polymerization zone while continually varying the compositional content of the primary feed source by continually adding a secondary polymerizable feed composition to the primary feed source. This process can be used to prepare polymers having a broad glass transition temperature by emulsion polymerizing a varying (e.g., continuously or step-wise) composition of hard and soft monomers.

In some embodiments, the continuously varying monomer feeds can provide a latex polymer with a gradient T_{g}. The gradient T_{g} latex polymer will typically have a DSC curve that exhibits no T_{g} inflection points, and could be said to have an essentially infinite number of T_{g} stages. For example, one may start with a higher T_{g} monomer feed and then at any point in the polymerization, including at time the higher T_{g} monomer feed begins, start to feed a lower T_{g} monomer composition into the higher T_{g} monomer feed. The resulting multistage latex polymer will have a gradient T_{g}, from high to low. In other embodiments, it may be favorable to feed a higher T_{g} monomer composition into a lower Tg monomer composition.

The latex emulsion, whether including (i) a mechanical mixture of a lower T_{g} (meth)acrylic copolymer and a higher T_{g} (meth)acrylic copolymer or (ii) a multi-stage latex including a higher T_{g} stage and a lower T_{g} stage, or a combination of (i) and (ii), may be used to form a cool roof coating for application over bituminous materials. In some preferred examples, the latex emulsion may be applied as a single-layer coating that exhibits both sufficient low temperature flexibility (e.g., flexibility to a temperature of at least −30° C.) and reduced or substantially no discoloration due to leaching of constituents of the bituminous materials into and/or through the coating over time.

While not wishing to be bound by any theory, presently available evidence indicates that the lower T_{g} (meth)acrylic copolymer contributes to the low temperature flexibility. In some examples, the measured T_{g} of the lower T_{g} (meth)acrylic copolymer may be selected based on a desired low temperature flexibility test temperature. For example, some municipalities or states require compliance with ASTM Standard D 6083 (2005) for roofing coatings. As part of ASTM Standard D 6083, the coating must pass a low temperature flexibility test defined by Test Method D 522, Method B. Test Method D 522 tests flexibility of a dry film with 0.36 mm thickness over a 13 mm mandrel at a temperature of −26° C. Prior to testing, the film is cured for 72 hours at 23±2° C. and 50±10% relative humidity, then for 120 hours at 50° C. The film is then exposed to accelerated weathering according to ASTM D 4798 for 1000 hours (6 weeks). Alternately the film is placed into a QUV chamber (available under the trade designation QUV Accelerated Weathering Tester from Q-LAB Corporation, Westlake, Ohio) set to oscillate between dry conditions with UV A radiation at 60° C. for about 8 hours and wet conditions without radiation at 50° C. for about 4 hours, with the total accelerated aging in the QUV chamber being performed for 1000 hours (six weeks).

Because the ASTM Standard D 6083 and Test Method D 522, Method B test low temperature flexibility at −26° C., the measured T_{g} of the lower T_{g} (meth)acrylic copolymer may be selected to be between about −35° C. and about −25° C. in some examples. However, in other examples, a temperature at which the coating is to exhibit flexibility may be different than −26° C. For example, a temperature at which the coating is to exhibit flexibility may be −10° C.

In general, the measured T_{g} of the lower T_{g} (meth)acrylic copolymer may be selected to be about no more than about 5° C. above the temperature at which the coating is to exhibit flexibility. As one example, if the coating is to exhibit flexibility at −10° C., the measured T_{g} of the lower T_{g} (meth)acrylic copolymer may be less than about −5° C. In other examples, the measured T_{g} of the lower T_{g} (meth)acrylic copolymer may be selected to be about equal to or less than the temperature at which the coating is to exhibit flexibility or may be selected to be within about 5° C. of the temperature at which the coating is to exhibit flexibility (i.e., the temperature at which the coating is to exhibit flexibility ±5° C.). As described above, the measured T_{g} of the lower T_{g} (meth)acrylic copolymer may be achieved by selecting appropriate monomers and ratios of monomers in the lower T_{g} (meth)acrylic copolymer.

While not wishing to be bound by any theory, presently available evidence indicates that the higher T_{g} (meth)acrylic copolymer contributes to reducing or substantially blocking (eliminating) migration of constituents from the bituminous roofing material into and/or through the coating to reduce or substantially eliminate discoloration (e.g., darkening) of the coating over time. Inclusion of the higher T_{g} (meth)acrylic copolymer may reduce mobility of constituents from the bituminous roofing material into and/or through the coating. In some examples, the monomers incorporated into the higher T_{g} (meth)acrylic copolymer (and, optionally, into the lower T_{g} (meth)acrylic copolymer) may be selected to have relatively low affinity to constituents from the bituminous roofing material. For example, the monomers incorporated into the higher T_{g} (meth)acrylic copolymer (and, optionally, into the lower T_{g} (meth)acrylic copolymer) may include relatively limited amounts, if any, of aryl-functional monomers, such as styrene. The measured T_{g} of the higher T_{g} (meth)acrylic copolymer may be achieved by selecting appropriate monomers and ratios of monomers in the higher T_{g} (meth)acrylic copolymer.

The blocking performance of the coating formed from the latex emulsion may be evaluated by applying 40 wet mils (about 1.016 wet mm) of the latex emulsion onto a polyester-reinforced app (atactic polypropylene) modified bitumen available under the trade designation APPEX® 4S from Johns Mansville, Denver, Colo., using a draw down bar. The wet latex emulsion is allowed to cure under ambient conditions for about 3 days. The dried coated bitumen sample is placed into a QUV chamber (available under the trade designation QUV Accelerated Weathering Tester from Q-LAB Corporation, Westlake, Ohio) set to oscillate between dry conditions with UV A radiation at 60° C. for about 8 hours and wet conditions without radiation at 50° C. for about 4 hours. Color measurements are taken initially (prior to being placed in the QUV chamber) and after three weeks (504 hours) aging in the QUV chamber. ΔE values are calculated by measuring values for the difference in lightness (L), difference in red and green (a), and difference in yellow and blue (b) for unexposed and exposed samples using a spectrophotometer (Datacolor Check II Plus, from Datacolor Inc., Lawrenceville, N.J.). The total color difference is then calculated using the following formula: ΔE=(ΔL²+Δa²+Δb²)⁵.

To evaluate the blocking performance, a model approximately representative of the current, leading commercial cool roof coating, an acrylic polymer available from Dow Chemical Co., Midland, Mich., under the trade designation RHOPLEX EC-1791, was designed. The synthesis of the model is described in Synthesis Model 1 below. The resulting copolymer had a measured T_{g} of −41° C. A coating formed from an aqueous coating composition prepared from Latex Emulsion Synthesis Model 1 according to Aqueous Coating Composition Synthesis Example 1 passed the −30° C. low temperature flexibility test described below and exhibited a ΔE after three-week accelerated weathering on the app modified bitumen of about 31.68.

The latex emulsions described herein may preferably exhibit a ΔE after three-week accelerated weathering on the app modified bitumen of less than Latex Emulsion Synthesis Model 1. In some examples, the latex emulsions described herein exhibit a ΔE after three-week accelerated weathering of at least 20% lower than that of Latex Emulsion Synthesis Model 1. In some examples, the latex emulsions described herein exhibit a ΔE after three-week accelerated weathering of at least 25% lower than that of Latex Emulsion Synthesis Model 1. In some examples, the latex emulsions described herein exhibit a ΔE after three-week accelerated weathering of at least 30% lower than that of Latex Emulsion Synthesis Model 1.

As described above, the higher T_{g} (meth)acrylic copolymer may have a measured T_{g} that is at least a threshold amount greater than the measured T_{g} of the lower T_{g} (meth)acrylic copolymer. In some examples, the threshold amount may be 15° C., or 20° C., or 25° C.

In this way, while the current application primarily describes a latex emulsion that includes a first, lower T_{g} (meth)acrylic copolymer or stage exhibiting a measured T_{g} between about −60° C. and about −5° C. and a second, higher T_{g} (meth)acrylic copolymer or stage exhibiting a measured glass transition temperature between about −10° C. and about 30° C., the concepts of the application may be extended to encompass latex emulsions used to form coatings having any selected flexibility temperature and improved bleed blocking. For example, a latex emulsion may include a first, lower T_{g} (meth)acrylic copolymer or stage exhibiting a measured T_{g} that is no more than about 5° C. above the temperature at which the coating is to exhibit flexibility and a second, higher T_{g} (meth)acrylic copolymer or stage exhibiting a measured T_{g} that is at least 15° C. more than the measured T_{g} of the first, lower T_{g} (meth)acrylic copolymer or stage. Such a latex emulsion is expected to produce a coating that will achieve the desired temperature flexibility while exhibiting improved bleed blocking compared to a latex emulsion including only the first, lower T_{g} (meth)acrylic copolymer or stage.

In some examples, the coating accomplishes the blocking and flexibility functions while including little or substantially no, or no, crosslinking promoting metal complex, such as little or substantially no, or no, zinc or zinc metal complexes. While such crosslinking promoting metal complexes may improve blocking performance of the coating, many municipalities, states, or countries have regulations limiting metal (such as zinc) content in run-off water. By reducing or substantially eliminating crosslinking promoting metal complexes in the latex emulsion, aqueous coating composition, and coating, the coating may provide sufficient blocking and flexibility properties while reducing or substantially eliminating concerns relating to metals leaching from the coating and contributing to metal content in run-off water. In some examples, the latex emulsion may include less than 0.5 weight percent, if any, or less than 0.1 weight percent, if any, of a crosslinking promoting metal complex, based on the total solids content of the latex emulsion. In some examples, the latex emulsion may include less than 0.5 weight percent, if any, or less than 0.1 weight percent, if any, of zinc or a zinc metal complex, based on the total solids content of the latex emulsion.

The latex emulsion may be used to coat substrates, e.g., as a primer coat or a topcoat. For example, the latex emulsion may be used to coat bituminous (e.g., asphaltic) roofing materials, such as alternating layers of tar paper and asphalt, a hot asphalt roofing material, or a roll of modified bitumen. In some preferred examples, the latex emulsion may be used as a single coating applied directly to the bituminous (e.g., asphaltic) roofing materials. The single coating may include two or more layers formed using the latex emulsion. In other examples, a coating system may include a layer formed using the latex emulsion and one or more optional layers (e.g., tie layers, primer layers, intermediate layers) between the bituminous (e.g., asphaltic) roofing materials and the layer formed using the latex emulsion. Additionally, or alternatively, a coating system may include a layer formed using the latex emulsion and one or more optional layers (e.g., top coats) over the layer formed using the latex emulsion. In some examples, more than one layer formed using the latex emulsion may be used in combination with one or more underlayers, one or more top coats, or both.

In some examples, rather than being used neat to coat a substrate, the latex emulsion may be part of an aqueous coating composition that include at least one additive. The at least one additive may include, for example, a dispersant, a biocide, a fungicide, an UV stabilizer, a thickener, a wetting agent, a defoamer, a filler, a pigment or colorant, or combinations thereof.

The aqueous coating composition may contain one or more optional ingredients that are VOCs. Such ingredients will be known to persons having ordinary skill in the art or can be determined using standard methods. Desirably, the coating compositions are low VOC, and preferably include less than 150 g/L (about 15% w/v), preferably not more than about 100 g/L (about 10% w/v), more preferably not more than about 50 g/L (about 5% w/v), and most preferably less than 20 g/L (about 2% w/v), for example not more than about 10 g/L (about 1% w/v) or not more than about 8 g/L (about 0.8% w/v) volatile organic compounds.

In some examples, the aqueous coating composition may include less than 0.5 weight percent, if any, or less than 0.1 weight percent, if any, of a crosslinking promoting metal complex. In some examples, the aqueous coating composition may include less than 0.5 weight percent, if any, or less than 0.1 weight percent, if any, of zinc or a zinc metal complex.

The aqueous coating composition may contain one or more optional coalescents to facilitate film formation. Coalescents suitable for use in the coating compositions will be known to persons having ordinary skill in the art or can be determined using standard methods. Exemplary coalescents include glycol ethers such those sold under the trade designations EASTMAN EP, EASTMAN DM, EASTMAN DE, EASTMAN DP, EASTMAN DB and EASTMAN PM from Eastman Chemical Company, Kingsport, Tenn., and ester alcohols such as those sold under the trade names TEXANOL ester alcohol from Eastman Chemical Company. The optional coalescent may be a low VOC coalescent such as is described in U.S. Pat. No. 6,762,230 B2. If present, the coating compositions may include a low VOC coalescent in an amount of at least about 0.5 parts by weight, or at least about 1 part by weight, and or at least about 2 parts by weight, based on total resin solids. The coating compositions also may include a low VOC coalescent in an amount of less than about 10 parts by weight, or less than about 6 parts by weight, or less than about 4 parts by weight, based on total resin solids.

Other optional additives for use in the aqueous coating compositions herein are described in Koleske et al., Paint and Coatings Industry, April, 2003, pages 12-86. Some performance enhancing additives that may be employed include coalescing solvent(s), defoamers, dispersants, amines, preservatives, biocides, mildewcides, fungicides, glycols, surface active agents, pigments, colorants, dyes, surfactants, thickeners, heat stabilizers, leveling agents, anti-cratering agents, curing indicators, plasticizers, fillers, sedimentation inhibitors, ultraviolet-light absorbers, optical brighteners, and the like to modify properties of the aqueous coating composition.

The disclosed coating compositions may include a surface-active agent (surfactant) that modifies the interaction of the coating composition with the substrate or with a prior applied coating. The surface-active agent affects qualities of the aqueous coating composition including how the aqueous coating composition is handled, how it spreads across the surface of the substrate, and how it bonds to the substrate. The surface-active agent can modify the ability of the aqueous coating composition to wet a substrate and also may be referred to as a wetting agent. Surface-active agents may also provide leveling, defoaming, or flow control properties, and the like. If the aqueous coating composition includes a surface-active agent, the surface-active agent is preferably present in an amount of less than 5 weight %, based on the total weight of the aqueous coating composition. Surface-active agents suitable for use in the coating composition will be known to persons having ordinary skill in the art or can be determined using standard methods. Some suitable surface-active agents include those available under the trade designations STRODEX KK-95H, STRODEX PLF100, STRODEX PK0VOC, STRODEX LFK70, STRODEX SEK50D and DEXTROL OC50 from Dexter Chemical L.L.C., Bronx, N.Y.; HYDROPALAT 100, HYDROPALAT 140, HYDROPALAT 44, HYDROPALAT 5040 and HYDROPALAT 3204 from Cognis Corporation, Cincinnati, Ohio; LIPOLIN A, DISPERS 660C, DISPERS 715W and DISPERS 750W from Degussa Corporation, Parsippany, N.J.; BYK 156, BYK 2001 and ANTI-TERRA 207 from Byk Chemie, Wallingford, Conn.; DISPEX A40, DISPEX N40, DISPEX R50, DISPEX G40, DISPEX GA40, EFKA 1500, EFKA 1501, EFKA 1502, EFKA 1503, EFKA 3034, EFKA 3522, EFKA 3580, EFKA 3772, EFKA 4500, EFKA 4510, EFKA 4520, EFKA 4530, EFKA 4540, EFKA 4550, EFKA 4560, EFKA 4570, EFKA 6220, EFKA 6225, EFKA 6230 and EFKA 6525 from Ciba Specialty Chemicals, Tarrytown, N.Y.; SURFYNOL CT-111, SURFYNOL CT-121, SURFYNOL CT-131, SURFYNOL CT-211, SURFYNOL CT 231, SURFYNOL CT-136, SURFYNOL CT-151, SURFYNOL CT-171, SURFYNOL CT-234, CARBOWET DC-01, SURFYNOL 104, SURFYNOL PSA-336, SURFYNOL 420, SURFYNOL 440, ENVIROGEM AD-01 and ENVIROGEM AE01 from Air Products & Chemicals, Inc., Allentown, Pa.; TAMOL 1124, TAMOL 850, TAMOL 681, TAMOL 731 and TAMOL SG-1 from Rohm and Haas Co., Philadelphia, Pa.; IGEPAL CO-210, IGEPAL CO-430, IGEPAL CO-630, IGEPAL CO-730, and IGEPAL CO-890 from Rhodia Inc., Cranbury, N.J.; T-DET and T-MULZ products from Harcros Chemicals Inc., Kansas City, Kans.; polydimethylsiloxane surface-active agents (such as those available under the trade designations SILWET L-760 and SILWET L-7622 from OSI Specialties, South Charleston, W.V., or BYK 306 from Byk-Chemie) and fluorinated surface-active agents (such as those commercially available as FLUORAD FC-430 from 3M Co., St. Paul, Minn.).

In some examples, the surface-active agent may be a defoamer. Some suitable defoamers include those sold under the trade names BYK 018, BYK 019, BYK 020, BYK 022, BYK 025, BYK 032, BYK 033, BYK 034, BYK 038, BYK 040, BYK 051, BYK 060, BYK 070, BYK 077 and BYK 500 from Byk Chemie; SURFYNOL DF-695, SURFYNOL DF-75, SURFYNOL DF-62, SURFYNOL DF-40 and SURFYNOL DF-110D from Air Products & Chemicals, Inc.; DEEFO 3010A, DEEFO 2020E/50, DEEFO 215, DEEFO 806-102 and AGITAN 31BP from Munzing Chemie GmbH, Heilbronn, Germany; EFKA 2526, EFKA 2527 and EFKA 2550 from Ciba Specialty Chemicals; FOAMAX 8050, FOAMAX 1488, FOAMAX 7447, FOAMAX 800, FOAMAX 1495 and FOAMAX 810 from Degussa Corp.; and FOAMASTER 714, FOAMASTER A410, FOAMASTER 111, FOAMASTER 333, FOAMASTER 306, FOAMASTER SA-3, FOAMASTER AP, DEHYDRAN 1620, DEHYDRAN 1923 and DEHYDRAN 671 from Cognis Corp.

The aqueous coating composition also may contain one or more optional pigments. Pigments suitable for use in the coating compositions will be known to persons having ordinary skill in the art or can be determined using standard methods. Some suitable pigments include titanium dioxide white, carbon black, lampblack, black iron oxide, red iron oxide, yellow iron oxide, brown iron oxide (a blend of red and yellow oxide with black), phthalocyanine green, phthalocyanine blue, organic reds (such as naphthol red, quinacridone red and toulidine red), quinacridone magenta, quinacridone violet, DNA orange, or organic yellows (such as Hansa yellow). The aqueous coating composition can also include a gloss control additive or an optical brightener, such as that commercially available under the trade designation UVITEX™ OB from Ciba-Geigy.

In some examples, the aqueous coating composition may include an optional filler or inert ingredient. Fillers or inert ingredients extend, lower the cost of, alter the appearance of, or provide desirable characteristics to the aqueous coating composition before and after curing. Fillers and inert ingredients suitable for use in the aqueous coating composition will be known to persons having ordinary skill in the art or can be determined using standard methods. Some suitable fillers or inert ingredients include, for example, clay, glass beads, calcium carbonate, talc, silicas, feldspar, mica, barytes, ceramic microspheres, calcium metasilicates, organic fillers, and the like. Suitable fillers or inert ingredients are preferably present in an aggregate amount of less than 15 weight %, based on the total weight of the aqueous coating composition.

In certain applications it may also be desirable to include in the aqueous coating composition a biocide, fungicide, or the like. Some suitable biocides or fungicides include those sold under the trade names ROZONE 2000, BUSAN 1292 and BUSAN 1440 from Buckman Laboratories, Memphis, Tenn.; POLYPHASE 663 and POLYPHASE 678 from Troy Chemical Corp., Florham Park, N.J.; and KATHON LX from Rohm and Haas Co.

The aqueous coating composition may also include other ingredients that modify properties of the aqueous coating composition as it is stored, handled, or applied, and at other or subsequent stages. Waxes, flatting agents, rheology control agents, mar and abrasion additives, and other similar performance enhancing additives may be employed as needed in amounts effective to upgrade the performance of the cured coating and the aqueous coating composition. Some suitable wax emulsions to improve coating physical performance include those sold under the trade names MICHEM Emulsions 32535, 21030, 61335, 80939M and 7173MOD from Michelman, Inc. Cincinnati, Ohio and CHEMCOR 20N35, 43A40, 950C25 and 10N30 from ChemCor of Chester, N.Y. Some suitable rheology control agents include those sold under the trade names RHEOVIS 112, RHEOVIS 132, RHEOVIS, VISCALEX HV30, VISCALEX AT88, EFKA 6220 and EFKA 6225 from Ciba Specialty Chemicals; BYK 420 and BYK 425 from Byk Chemie; RHEOLATE 205, RHEOLATE 420 and RHEOLATE 1 from Elementis Specialties, Hightstown, N.J.; ACRYSOL L TT-615, ACRYSOL RM-5, ACRYSOL RM-6, ACRYSOL RM-8W, ACRYSOL RM-2020 and ACRYSOL RM-825 from Rohm and Haas Co.; NATROSOL 250LR from Hercules Inc., Wilmington, Del. and CELLOSIZE QP09L from Dow Chemical Co., Midland, Mich. Desirable performance characteristics of the coating include adhesion, chemical resistance, abrasion resistance, hardness, gloss, reflectivity, appearance, or combinations of these characteristics, and other similar characteristics. For example, the composition may include abrasion resistance promoting adjuvants such as silica or aluminum oxide (e.g., sol gel processed aluminum oxide).

In certain applications it may also be desirable to include in the aqueous coating composition an optional UV stabilizer or UV absorber. Concentration of the optional UV stabilizer or UV absorber in the aqueous coating composition will be known to persons having ordinary skill in the art or can be determined using standard methods. UV stabilizers may include encapsulated hydroxyphenyl-triazine compositions and other compounds known to persons having ordinary skill in the art, for example, TINUVIN 477DW, commercially available from BASF Corporation. UV absorbers may include, for example, a benzophenone, a benzophenone derivative, or a substituted benzophenone. For example, the UV absorber may include 2,4,6-trimethylbenzophenone, 4-methylbenzophenone, benzophenone, 2,2-dimethoxy-1,2-diphenylethanone, methyl-2-benzoyl benzoate1-Hydroxycyclohexyl phenyl ketone, 2-hydroxy-2-methyl-1-phenyl-1-propanone, methylbenzoylformate, benzoin ethyl ether, 4′-ethoxyacetophenone, 4,4-Bis(diethylamino)benozphenone, 2-benzyl-2-(dimethylamino)-4′-morpholinobutryophenone, benzophenone hydrazine, or the like.

In some examples, the aqueous coating composition may optionally include a thickener. Thickeners may include hydroxyethyl cellulose; hydrophobically modified ethylene oxide urethane; processed attapulgite, a hydrated magnesium aluminosilicate; and other thickeners known to persons having ordinary skill in the art. For example, thickeners may include CELLOSIZE QP-09-L and ACRYSOL RM-2020NPR, available from Dow Chemical Company; and ATTAGEL 50, available from BASF Corporation. Concentration of the optional thickener stabilizer in the aqueous coating composition will be known to persons having ordinary skill in the art or can be determined using standard methods.

Like the latex emulsion, the aqueous coating composition may be used to coat substrates, e.g., as a primer coat or a topcoat. In some preferred examples, the aqueous coating composition may be used as a single coating applied directly to the bituminous (e.g., asphaltic) roofing materials. The single coating may include two or more layers formed using the aqueous coating composition. In other examples, a coating system may include a layer formed using the aqueous coating composition and one or more optional layers (e.g., tie layers, primer layers, intermediate layers) between the bituminous (e.g., asphaltic) roofing materials and the layer formed using the aqueous coating composition. Additionally, or alternatively, a coating system may include a layer formed using the aqueous coating composition and one or more optional layers (e.g., top coats) over the layer formed using the aqueous coating composition. In some examples, more than one layer formed using the aqueous coating composition may be used in combination with one or more underlayers, one or more top coats, or both. The coating, whether formed from a neat latex or a aqueous coating composition, may be applied to an installed bituminous roof substrate or may be applied on a roll of modified bitumen prior to installation on a roof.

### EXAMPLES

The disclosure is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Mo.

### Latex Emulsion Synthesis Example 1

A monomer emulsion was made by first adding 330 g deionized water and 46.7 g DISPONIL FES 32 (a fatty alcohol ether sulphate available from BASF, Ludwigshafen, Germany) to a beaker and agitating. Then, each of the following was added: 26.6 g methacrylic acid, 7.0 g SIPOMER PAM 4000 (an ethylmethacrylate phosphate available from Solvay S.A., Brussels, Belgium), 1.0 g ammonium hydroxide (28%), 34.6 g butyl acrylate, 728 g 2-ethylhexyl acrylate, and 140 g methyl methacrylate.

To a 3-liter cylindrical flask was charged 400 grams (g) deionized water, 1.4 g sodium bicarbonate, and 31 g acrylic seed latex with 45% non-volatile material. An oxidizer solution was prepared by adding 4.0 g t-butyl hydroperoxide to 95 g deionized water with agitation, and a reducer solution was prepared by adding 2.8 g BRUGGOLITE FF6 (available from BruggemannChemical U.S., Inc., Newtown Square, Pa.) to 95 g deionized water with agitation. When the reaction flask had equilibrated at 60° C., 25% of the oxidizer solution and 25% of the reducer solution were added to the flask along with 8 drops of a 6% iron catalyst solution.

The monomer emulsion was fed to the flask over the course of 3 hours. Simultaneously, the remainder of the oxidizer solution and the reducer solution were fed to the flask over 4 hours. Temperature of the flask was maintained at between 60° C. and 80° C. throughout the additions.

At the conclusion of the oxidizer solution and reducer solution feeds, the flask was cooled to 40° C., at which time 2.0 g of ammonium hydroxide and 8.0 g of Proxel AQ (a 9.25% aqueous solution of 1,2-benzisothiazolin-3-one available from Lonza Group Ltd., Basel Switzerland) were added to the flask. The feed lines were rinsed with 90 g deionized water and fed to the reaction flask.

The resulting latex emulsion had a solids content of about 55.1%, a pH of about 5.47, a volume average particle size of about 212 nm, and a measured T_{g} of about −41° C.

### Latex Emulsion Synthesis Example 2

A monomer emulsion was made by first adding 330 g deionized water and 46.7 g DISPONIL FES 32 to a beaker and agitating. Then, each of the following was added: 26.6 g methacrylic acid, 7.0 g SIPOMER PAM 4000, 1.0 g ammonium hydroxide (28%), 554 g butyl acrylate and 798 g 2-ethylhexyl acrylate.

To a 3-liter cylindrical flask was charged 400 grams (g) deionized water, 1.4 g sodium bicarbonate, and 31 g acrylic seed latex with 45% non-volatile material. An oxidizer solution was prepared by adding 4.0 g t-butyl hydroperoxide to 95 g deionized water with agitation, and a reducer solution was prepared by adding 2.8 g BRUGGOLITE FF6 (available from Bruggemann Chemical U.S., Inc., Newtown Square, Pa.) to 95 g deionized water with agitation. When the reaction flask had equilibrated at 60° C., 25% of the oxidizer solution and 25% of the reducer solution were added to the flask along with 8 drops of a 6% iron catalyst solution.

The monomer emulsion was fed to the flask over the course of 3 hours. Simultaneously, the remainder of the oxidizer solution and the reducer solution were fed to the flask over 4 hours. Temperature of the flask was maintained at between 60° C. and 80° C. throughout the additions.

At the conclusion of the oxidizer solution and reducer solution feeds, the flask was cooled to 40° C., at which time 2.0 g of ammonium hydroxide and 8.0 g of Proxel AQ were added to the flask. The feed lines were rinsed with 90 g deionized water and fed to the reaction flask

The resulting latex emulsion had a solids content of about 55.2%, a pH of about 5.7, a volume average particle size of about 315 nm, and a measured T_{g} of about −49° C.

### Latex Emulsion Synthesis Example 3

A monomer emulsion was made by first adding 330 g deionized water and 46.7 g DISPONIL FES 32 to a beaker and agitating. Then, each of the following was added: 26.6 g methacrylic acid, 7.0 g SIPOMER PAM 4000, 1.0 g ammonium hydroxide (28%), and 1352 g 2-ethylhexyl acrylate.

To a 3-liter cylindrical flask was charged 400 grams (g) deionized water, 1.4 g sodium bicarbonate, and 31 g acrylic seed latex with 45% non-volatile material. An oxidizer solution was prepared by adding 4.0 g t-butyl hydroperoxide to 95 g deionized water with agitation, and a reducer solution was prepared by adding 2.8 g BRUGGOLITE FF6 to 95 g deionized water with agitation. When the reaction flask had equilibrated at 60° C., 25% of the oxidizer solution and 25% of the reducer solution were added to the flask along with 8 drops of a 6% iron catalyst solution.

The monomer emulsion was fed to the flask over the course of 3 hours. Simultaneously, the remainder of the oxidizer solution and the reducer solution were fed to the flask over 4 hours. Temperature of the flask was maintained at between 60° C. and 80° C. throughout the additions.

At the conclusion of the oxidizer solution and reducer solution feeds, the flask was cooled to 40° C., at which time 2.0 g of ammonium hydroxide and 8.0 g of Proxel AQ were added to the flask. The feed lines were rinsed with 90 g deionized water and fed to the reaction flask

The resulting latex emulsion had a solids content of about 55.0%, a pH of about 5.61, a volume average particle size of about 398 nm, and a measured T_{g} of about −58° C.

### Latex Emulsion Synthesis Example 4

A monomer emulsion was made by first adding 330 g deionized water and 46.7 g DISPONIL FES 32 to a beaker and agitating. Then, each of the following was added: 26.6 g methacrylic acid, 7.0 g SIPOMER PAM 4000, 1.0 g ammonium hydroxide (28%), 629 g butyl acrylate and 726 g methyl methacrylate.

To a 3-liter cylindrical flask was charged 400 grams (g) deionized water, 1.4 g sodium bicarbonate, and 31 g acrylic seed latex with 45% non-volatile material. An oxidizer solution was prepared by adding 4.0 g t-butyl hydroperoxide to 95 g deionized water with agitation, and a reducer solution was prepared by adding 2.8 g BRUGGOLITE FF6 to 95 g deionized water with agitation. When the reaction flask had equilibrated at 60° C., 25% of the oxidizer solution and 25% of the reducer solution were added to the flask along with 8 drops of a 6% iron catalyst solution.

The monomer emulsion was fed to the flask over the course of 3 hours. Simultaneously, the remainder of the oxidizer solution and the reducer solution were fed to the flask over 4 hours. Temperature of the flask was maintained at between 60° C. and 80° C. throughout the additions.

At the conclusion of the oxidizer solution and reducer solution feeds, the flask was cooled to 40° C., at which time 2.0 g of ammonium hydroxide and 8.0 g of Proxel AQ were added to the flask. The feed lines were rinsed with 90 g deionized water and fed to the reaction flask.

The resulting latex emulsion had a solids content of about 54.5%, a pH of about 5.75, a volume average particle size of about 190 nm, and a measured T_{g} of about 21° C.

### Latex Emulsion Synthesis Example 5

A first monomer emulsion was made by first adding 150 g deionized water and 20 g DISPONIL FES 32 to a first beaker and agitating. Then, each of the following was added: 16.8 g methacrylic acid, 11.4 g uriedo functional methacrylate, 3.0 g ammonium hydroxide (28%), 330 g butyl acrylate, 228 g methyl methacrylate, and 0.9 g dodecyl mercaptan.

A second monomer emulsion was made by first adding 150 g deionized water and 20 g DISPONIL FES 32 to a first beaker and agitating. Then, each of the following was added: 16.8 g methacrylic acid, 11.4 g uriedo functional methacrylate, 3.0 g ammonium hydroxide (28%), 168 g butyl acrylate, 241 g 2-ethylhexyl acrylate, 161.6 g methyl methacrylate, and 0.6 g dodecyl mercaptan.

An initiator solution of 1.2 g ammonium persulfate in 90 g deionized water was prepared to use as a co-feed throughout the polymerization.

To a 3-liter cylindrical flask was charged 400 grams (g) deionized water and 40 g acrylic seed latex with 30% non-volatile material. The flask was fitted with an agitator and flask head and placed in a water bath heated to 80° C. When the reaction flask reached 78° C., 3.6 g ammonium persulfate in 30 g deionized water was added to the flask and allowed to react for 5 minutes before beginning the feed of the first monomer emulsion to the flask over 90 minutes and beginning the feed of the initiator co-feed to the flask over 180 minutes.

Upon completion of the 90-minute feed of the first monomer emulsion, the feed lines were rinsed with 20 g deionized water. The second monomer emulsion was then fed to the flask over 90 minutes. The lines were rinsed with 90 g of deionized water after completion of the second monomer emulsion feed, and the flask was held at 80° C. for 45 minutes.

Following the 45-minute hold, the flask was cooled to 60° C. and a redox hit of 1.2 g t-butyl hydroperoxide and 1.0 g erythorbic acid were added to the flask. After 20 minutes, the flask was cooled to 40° C. at which time 8.0 g of ammonium hydroxide and 8.0 g of Proxel AQ were added to the flask.

The resulting two-stage latex emulsion had a solids content of about 54.9%, a pH of about 8.2, and a volume average particle size of about 170 nm.

### Latex Emulsion Synthesis Examples 6-13

The latex emulsions in Table 1 below were prepared with the synthesis procedures outlined in the Latex Emulsion Synthesis Examples 1-5 set forth above. In Table 1, BA refers to butyl acrylate, MMA refers to methylmethacrylate, and EHA refers to 2-ethylhexylacrylate. The T_{g}s recited in Table 1 are calculated values obtained using the Fox equation.

The compositions in Table 1 recite the total polymer in each latex emulsion. The ratios of the lower T_{g} stage to the higher T_{g} stage were 50/50 in Examples 6-12, while in Example 13 the ratio of the lower T_{g} stage to the higher T_{g} stage was 60/40. In Table 1, the percentages will not necessarily add to 100% since other components of the emulsion (for example, surfactant, initiator, and the like) are omitted for clarity.

TABLE 1

| | Fox T_{g} | | | Fox T_{g} | | | |
|---|---|---|---|---|---|---|---|
| | of | | | of | | | |
| | Higher | | | Lower | | | |
| | T_{g} | | | T_{g} | | | |
| | Stage | BA | MMA | Stage | BA | MMA | EHA |
| Example | (° C.) | (wt %) | (wt %) | (° C.) | (wt %) | (wt %) | (wt %) |
| 6 | −4.8 | 26.37 | 18.00 | −37.5 | 13.00 | 11.65 | 19.60 |
| 7 | −0.3 | 25.10 | 19.67 | −25.9 | 21.70 | 13.00 | 9.15 |
| 8 | −0.4 | 25.87 | 20.30 | −26 | 22.35 | 13.85 | 10.00 |
| 9 | −4.9 | 27.50 | 18.82 | −37.3 | 13.50 | 20.30 | 12 |
| 10 | −4.8 | 26.37 | 18.00 | −26.8 | 16.60 | 7.65 | 20.00 |
| 11 | −4.8 | 26.37 | 18.00 | −56.8 | 21.60 | 2.65 | 20.00 |
| 12 | −4.8 | 26.37 | 18.00 | −42.6 | 14.75 | 9.50 | 20.00 |
| 13 | −4.7 | 20.42 | 13.95 | −37.6 | 21.25 | 13.00 | 20.00 |

### Latex Emulsion Synthesis Example 14 (Prophetic)

The components utilized in Latex Emulsion Synthesis Example 5 above could be made as a gradient, or powerfeed polymer using the process described below.

A first monomer emulsion is made by first adding 150 g deionized water and 20 g DISPONIL FES 32 to a first beaker and agitating. Then, each of the following is added: 16.8 g methacrylic acid, 11.4 g uriedo functional methacrylate, 3.0 g ammonium hydroxide (28%), 330 g butyl acrylate, 228 g methyl methacrylate, and 0.9 g dodecyl mercaptan.

A second monomer emulsion is made by first adding 150 g deionized water and 20 g DISPONIL FES 32 to a first beaker and agitating. Then, each of the following is added: 16.8 g methacrylic acid, 11.4 g uriedo functional methacrylate, 3.0 g ammonium hydroxide (28%), 168 g butyl acrylate, 241 g 2-ethylhexyl acrylate, 161.6 g methyl methacrylate, and 0.6 g dodecyl mercaptan.

An initiator solution of 1.2 g ammonium persulfate in 90 g deionized water is prepared to use as a co-feed throughout the polymerization.

To a 3-liter cylindrical flask is charged 400 grams (g) deionized water and 40 g acrylic seed latex with 30% non-volatile material. The flask is fitted with an agitator and flask head, and placed in a water bath heated to 80° C. When the reaction flask reached 78° C., 3.6 g ammonium persulfate in 30 g deionized water is added to the flask and allowed to react for 5 minutes.

Following the seed reaction, the feed of the first monomer emulsion to the reactor is begun at a 90 minute rate (based on the weight of monomer emulsion 1 only). Simultaneously, the feed of the second monomer emulsion into the first monomer emulsion is begun at a 2.75 hour rate. As such, the total monomer feed to the reactor is completed in 3 hours, with the feed of the second monomer emulsion into the first monomer emulsion finishing at 2.75 hours.

Upon completion of the monomer feeds, the lines are rinsed with 90 g of deionized water, and the flask is held at 80° C. for 45 minutes. Following the 45-minute hold, the flask is cooled to 60° C. and a redox hit of 1.2 g t-butyl hydroperoxide and 1.0 g erythorbic acid added to the flask. After 20 minutes, the flask is cooled to 40° C. at which time 8.0 g of ammonium hydroxide and 8.0 g of Proxel™ AQ is added to the flask.

### Aqueous Coating Composition Synthesis Example 1

TABLE 2

| Item Number | Material | Mass (g) |
|---|---|---|
| 1 | Water | 154.90 |
| 2 | Tamol 165A | 11.00 |
| 3 | Ammonium Hydroxide | 3.00 |
| 4 | Foamaster 111 | 5.00 |
| 5 | R-960 | 60.00 |
| 6 | Duramite | 400.00 |
| 7 | Foamaster 111 | 5.00 |
| 8 | Latex (about 55% solids) | 490.00 |
| 9 | Texanol | 6.74 |
| 10 | Polyphase 663 | 10.87 |
| 11 | Propylene Glycol | 11.00 |
| 12 | Natrosol 250HBR | 3.00 |
| Total | | 1160.51 |

Tamol 165A is a hydrophobic copolymer pigment dispersant including a polycarboxylate ammonium salt, residual monomers, and water available from Dow Chemical Company, Midland, Mich. Foamaster 111 is a non-ionic liquid defoamer for water-based paints and coatings, water-based printing inks, and latex adhesive systems available from BASF, Ludwigshafen, Germany. R-960 is a titanium dioxide pigment including titanium dioxide, alumina, and amorphous silica available from E. I. du Pont de Nemours and Company, Wilmington, Del. under the trade designation DuPont Ti-Pure R-960. Duramite is a medium particle size marble extender available from Imerys Carbonates, Paris, France. Texanol is an ester alcohol coalescent available from Eastman Chemical Company, Kingsport, Tenn. Polyphase 663 is a zero VOC, water-based dispersion of fungicides and an algaecide available from Troy Corporation, Florham Park, N.J. Natrosol 250 HB is a hydroxyethylcellulose available from Ashland Global Specialty Chemicals, Covington, Ky.

The mixture identified in Aqueous Coating Composition Synthesis Example 1 was used with the respective latexes of Latex Emulsion Synthesis Examples 1-5 in respective formulations to generate aqueous coating compositions used in the following Coating Examples.

Items 1-6 from Table 2 were added in order then mixed for 20 minutes under high shear using a cowls blade. After 20 minutes, the cowls blade was changed to a propeller type and materials 7-10 were added slowly with good mixing. Items 11 and 12 were mixed together then added. The final mixture was then mixed for an additional 20 minutes with a good vortex. A representative aqueous coating composition had the properties shown in Table 3.

TABLE 3

| Property | Value | Units |
|---|---|---|
| Weight Solids | 64.59 | % |
| Volume Solids | 50.58 | % |
| Pigment Volume Content | 40.14 | % |
| Volatile Organic | 40 | g/liter |
| Compounds | | |
| Weight per gallon | 11.61 | pounds/gallon |
| Viscosity | 104.00 | KU |

### Coating Examples

Low temperature flexibility was tested according to ASTM D6083 and ASTM-D-522 using a ½ inch diameter mandrel, but using free films rather than material cast onto aluminum panels. Aqueous coating compositions were prepared according to Aqueous Coating Composition Synthesis Example 1, with the generic “Latex” of Table 1 replaced with the specific latexes identified in Tables 4-8.

Samples for bleed through resistance testing were prepared by applying 40 wet mils (about 1.016 wet mm) of material onto a polyester-reinforced app (atactic polypropylene) modified bitumen available under the trade designation APPEX® 4S from Johns Mansville, Denver, Colo., using a draw down bar. The samples were allowed to cure under ambient conditions for about 3 days. The cured samples were then placed into a QUV chamber (available under the trade designation QUV Accelerated Weathering Tester from Q-LAB Corporation, Westlake, Ohio) set to oscillate between dry conditions with UV A radiation at 60° C. for about 8 hours and wet conditions without radiation at 50° C. for about 4 hours. Color measurements were taken initially (prior to being placed in the QUV chamber) and after three weeks (504 hours) aging in the QUV chamber. ΔE values were calculated by measuring values for the difference in lightness (L), difference in red and green (a), and difference in yellow and blue (b) for unexposed and exposed samples using a spectrophotometer (Datacolor Check II Plus, from Datacolor Inc., Lawrenceville, N.J.). The total color difference was then calculated using the following formula: ΔE=(ΔL²+Δa²+Δb²)^{0.5}. MB 3640 is a 100% acrylic polymer available under the trade designation LIPACRYL MB-3640 from Dow Chemical Co., Midland, Mich. EC-1791 is an acrylic polymer available under the trade designation RHOPLEX EC-1791 from Dow Chemical Co., Midland, Mich. 2719 and 2126 are all-acrylic emulsions available under the trade designation EPS 2719 and EPS 2126, respectively, from Engineered Polymer Solutions, Marengo, Ill. EPS 2719 and EPS 2126 were blended in a 50:50 ratio by weight.

TABLE 4

| | | −30° C. | |
|---|---|---|---|
| | Measured | Flexibility | |
| Latex | T_{g} (° C.) | Test | 3 Week ΔE |
| Example 1 | −41 | Pass | 31.68 |
| Example 2 | −49 | Pass | 30.68 |
| Example 3 | −58 | Pass | 31.00 |
| Example 4 | 21 | Fail | 3.70 |
| 2719 | −4 | Fail | 6.35 |
| MB 3640 | −7 | Fail | 13.68 |
| EC-1791 | −34 | Pass | 26.09 |
| 2719/2126 | −4/−26 | Pass | 14.14 |

TABLE 5

| | | | −30° C. | |
|---|---|---|---|---|
| | | | Flexibility | |
| Latex 1 | Latex 2 | % Latex 2 | Test | 3 Week ΔE |
| Example 4 | Example 3 | 100 | Pass | 31.00 |
| Example 4 | Example 3 | 70 | Pass | 32.61 |
| Example 4 | Example 3 | 60 | Pass | 33.48 |
| Example 4 | Example 3 | 50 | Pass | 29.89 |
| Example 4 | Example 3 | 40 | Fail | 29.76 |
| Example 4 | Example 3 | 30 | Fail | 26.09 |
| Example 4 | Example 3 | 0 | Fail | 3.70 |

TABLE 6

| | | | −30° C. | |
|---|---|---|---|---|
| | | | Flexibility | |
| Latex 1 | Latex 2 | % Latex 2 | Test | 3 Week ΔE |
| Example 4 | Example 2 | 100 | Pass | 30.68 |
| Example 4 | Example 2 | 70 | Pass | 31.61 |
| Example 4 | Example 2 | 60 | Pass | 23.64 |
| Example 4 | Example 2 | 50 | Pass | 23.29 |
| Example 4 | Example 2 | 40 | Fail | 25.32 |
| Example 4 | Example 2 | 30 | Fail | 17.53 |
| Example 4 | Example 2 | 0 | Fail | 3.70 |

TABLE 7

| | | | −30° C. | |
|---|---|---|---|---|
| | | | Flexibility | |
| Latex 1 | Latex 2 | % Latex 2 | Test | 3 Week ΔE |
| Example 4 | Example 1 | 100 | Pass | 31.68 |
| Example 4 | Example 1 | 70 | Pass | 25.74 |
| Example 4 | Example 1 | 60 | Pass | 24.57 |
| Example 4 | Example 1 | 50 | Pass | 13.26 |
| Example 4 | Example 1 | 40 | Fail | 15.13 |
| Example 4 | Example 1 | 30 | Fail | 10.96 |
| Example 4 | Example 1 | 0 | Fail | 3.70 |

Delta E for all the “soft” polymers (Examples 1-3) were approximately 31. Delta E for the “hard” polymer (Example 4) was 3.7. The data indicate that, for blends, Delta E falls between these two extremes. As the ratio of the “soft” polymer increases, Delta E increases. Similarly, as the T_{g} of the “soft” polymer decreases, Delta E increases. Low temperature flexibility shows a distinct change from pass to fail at about 50/50 blend regardless of the T_{g} of the “soft” polymer.

TABLE 8

| | | −30° C. | |
|---|---|---|---|
| | | Flexibility | |
| Latex | T_{g} (° C.) | Test | 3 Week ΔE |
| 2129 | −22 | Pass | |
| 2719 | −4 | Fail | 6.07 |
| Example 5 | N/A | Pass | 15.29 |

2719 and 2129 are all-acrylic emulsions available under the trade designation EPS 2719 and EPS 2129, respectively, from Engineered Polymer Solutions, Marengo, Ill.

### Aqueous Coating Composition Synthesis Example 2

An aqueous coating composition was formulated with the ingredients shown in Table 9.

TABLE 9

| Item Number | Material | Mass (g) |
|---|---|---|
| 1 | Water | 119 |
| 2 | Polyacid Dispersant | 5.3 |
| 3 | Defoamer | 2.7 |
| 4 | Clay Thickener | 2.2 |
| 5 | Latex (55% solids) | 250 |
| 6 | T1O2 | 65 |
| 7 | Extender | 322 |
| 8 | Zinc | 32 |
| 9 | Ammonium hydroxide | 2 |
| 10 | Latex (55% solids) | 285 |
| 11 | Coalescent | 20 |
| 12 | Defoamer | 2.5 |
| 13 | HEUR Thickener | 0.5 |
| Total | | 1108.2 |

Items 1-9 from Table 9 were added in order then mixed for 20 minutes under high shear using a cowls blade. After 20 minutes, the cowls blade was changed to a propeller type and materials 10-13 were added slowly with good mixing. The final mixture was then mixed for an additional 20 minutes with a good vortex. The aqueous coating composition had the properties shown in Table 10.

TABLE 10

| Property | Value | Units |
|---|---|---|
| Weight Solids | 65.33 | % |
| Volume Solids | 53.60 | % |
| Pigment Volume Content | 36.73 | % |
| Weight Binder | 26.42 | % |
| Volume Binder | 33.19 | % |
| Weight Pigment | 37.88 | % |
| Volume Pigment | 19.27 | % |
| Pigment/Binder Ratio | 1.43 | |
| Volatile Organic | 48 | g/liter |
| Compounds | | |
| Volatile Organic | 0.40 | Pounds/gallon |
| Compounds | | |
| Weight per gallon | 11.10 | pounds/gallon |

Two samples were prepared using the procedure from Latex Emulsion Synthesis Example 3, except the 2-ethylhexyl acrylate (EHA) was replaced with the monomers listed in Table 11. MMA is methyl methacrylate. The latexes were then formulated to aqueous coating compositions using Aqueous Coating Composition Synthesis Example 2.

TABLE 11

| | EHA | Styrene | MMA | Measured | |
|---|---|---|---|---|---|
| | (g) | (g) | (g) | T_{g}(° C.) | BB DE |
| Example 6 | 814 | 0 | 538 | −6.97 | 1.84 |
| Example 7 | 814 | 270 | 268 | −7.47 | 4.53 |

EHA is ethyl hexyl acrylate, MMA is methyl methacrylate, and BB DE is bleed block as measured in ΔE units. The aqueous coating compositions were coated at a 20-mil (about 0.5 mm) wet thickness on an atactic polypropylene (APP) polymer and asphalt blend surfaced with fine mineral parting agent on top of the sheet available under the trade designation APPEX® 4S from Johns Mansville, Denver, Colo. A polyolefin burn-off film is on the bottom side. Initial lab color values were measured on each sample and then the sample was placed in a 50° C. oven for two weeks. Aged lab color values were measured, and Delta E was calculated for each in the manner described above. As the accelerated aging was less extensive than for those samples aged in the QUV chamber, the ΔE values are less. Samples containing 20% styrene had similar glass transition temperatures but higher Delta E values than those without styrene.

### Dirt Pick Up Resistance Example

For dirt pickup resistance testing, a red-oxide slurry method was employed. A coating formed an aqueous coating composition according to Table 1 and the latex of Latex Emulsion Synthesis Example 5 was applied to a first 3″×6″ aluminum panel using a 20-mil draw down bar. As a comparison, a coating formed from EC-1791 was applied to a second 3″×6″ aluminum panel using a 20-mil draw down bar. The coatings were allowed to dry for 24 hours at room temperature and then placed into a QUV chamber for 7 days. The panels cycled through 8-hour QUV-A and 4-hour condensation cycles according to ASTM G154. The panels were taken out after 1-week exposure and blotted dry if necessary. A red-oxide slurry was made up of 50 g red iron oxide, 40 g yellow iron oxide, and 10 g black iron oxide pigment that was hand stirred or shaken until homogenous. A mixture of 0.5 g TAMOL 731 (Rohm and Haas Co., Philadelphia, Pa.) was added to 200 g deionized water with agitation was prepared. The pigment was slowly added and mixed for 30 minutes until a smooth slurry was formed. The red oxide slurry was applied to half of each of the coated panels using a foam applicator. The slurry was allowed to dry on the panels at room temperature for 3-4 hours; the slurry must be dry before proceeding to next step. The slurry was then gently washed off each panel by running under water and using a small piece of cheesecloth, rubbing lightly. A clean cloth was used for each panel. The panels were dried gently with a dry paper towel and allowed to dry completely before measuring ΔE values using a spectrophotometer as described above. The ΔE for the coating formed from the latex of Latex Emulsion Synthesis Example 5 was about 7, and the ΔE for EC-1791 was about 40.

The complete disclosure of all patents, patent applications, and publications, and electronically available material cited herein are incorporated by reference. The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims. The disclosure illustratively disclosed herein suitably may be practiced, in some examples, in the absence of any element which is not specifically disclosed herein. Various examples have been described. These and other examples are within the scope of the following claims.

1-45. (canceled)

46. A latex emulsion, comprising:
an aqueous carrier liquid; and
either:
a first (meth)acrylic copolymer or stage exhibiting a measured glass transition temperature of about −60° C. to about −5° C.; and
a second (meth)acrylic copolymer or stage exhibiting a measured glass transition temperature of about −10° C. to about 30° C.; wherein the first and second (meth)acrylic copolymers or stages comprise less than about 20 weight percent styrene, if any, based on the total weight of emulsion polymerized ethylenically unsaturated monomers in the first and second (meth)acrylic copolymers or stages; or
one or more gradient emulsion copolymers having a broad measured T_{g}, wherein the one or more gradient emulsion copolymers is a reaction product of a first (meth)acrylic monomer composition which, when polymerized, would provide a (meth)acrylic copolymer having a measured T_{g} of about −60° C. to about −5° C. and a second (meth)acrylic monomer composition which, when polymerized, would provide a copolymer having a measured T_{g} of about −10° C. to about 30° C., wherein relative proportions of the a first (meth)acrylic monomer composition and the second (meth)acrylic monomer composition changes during formation of the one or more gradient emulsion copolymers.

47. The latex emulsion of claim 46, wherein the first (meth)acrylic copolymer or stage or the first (meth)acrylic monomer composition exhibits a measured glass transition temperature of about −25° C. to about −15° C., and wherein the second (meth)acrylic copolymer or stage or the second (meth)acrylic monomer composition exhibits a measured glass transition temperature of about 0° C. to about 10° C.

48. The latex emulsion of claim 46, wherein the first (meth)acrylic copolymer or stage is formed from or the first (meth)acrylic monomer composition comprises monomers comprising butyl acrylate, 2-ethylhexylacrylate, or combinations thereof.

49. The latex emulsion of claim 46, wherein the first (meth)acrylic copolymer or stage is formed from or the first (meth)acrylic monomer composition comprises monomers comprising butyl acrylate, 2-ethylhexylacrylate, and methyl methacrylate, and wherein the second (meth)acrylic copolymer or stage is formed from or the second (meth)acrylic monomer composition comprises monomers comprising methyl methacrylate, butyl methacrylate, or combinations thereof.

50. The latex emulsion of claim 46, wherein a combination of the first and second (meth)acrylic copolymers or stages or a combination of the first and second (meth)acrylic monomer compositions comprise less than about 10 weight percent styrene, if any, based on the total weight of emulsion polymerized ethylenically unsaturated monomers in the first and second (meth)acrylic copolymers or stages or the combination of the first and second (meth)acrylic monomer compositions.

51. The latex emulsion of claim 46, wherein the monomers used to form the first (meth)acrylic copolymer or stage, or the monomers used to form the second (meth)acrylic copolymer or stage, or the first (meth)acrylic monomer composition, or the second (meth)acrylic monomer composition comprise between about 0.1 and about 10 weight percent of an ethylenically unsaturated polar monomer component, based on the total weight of the first (meth)acrylic copolymer or stage or the second (meth)acrylic copolymer or stage.

52. The latex emulsion of claim 51, wherein the ethylenically unsaturated polar monomer component comprises an acid-functional or anhydride-functional ethylenically unsaturated monomer, or an at least partially neutralized variant thereof.

53. The latex emulsion of claim 52, wherein the ethylenically unsaturated acid-functional or anhydride-functional monomer comprises acrylic acid, methacrylic acid, an at least partially neutralized acrylic acid, an at least partially neutralized methacrylic acid, or combinations thereof.

54. The latex emulsion of claim 46, wherein the monomers used to form the first (meth)acrylic copolymer or stage, or the monomers used to form the second (meth)acrylic copolymer or stage, or the first (meth)acrylic monomer composition, or the second (meth)acrylic monomer composition further comprise a ureido-functional monomer.

55. The latex emulsion of claim 46, wherein the emulsion comprises less than about 25 g/L volatile organic compounds.

56. The latex emulsion of claim 46, wherein a coating formed from the latex emulsion exhibits a ΔE after 3-week QUV accelerated weathering of at least 20% less than a coating formed from the latex emulsion of Latex Emulsion Synthesis Example 1.

57. The latex emulsion of claim 46, wherein a film formed from the latex emulsion exhibits low temperature flexibility according to ASTM D-6083 at −26° C.

58. The latex emulsion of claim 46, comprising between about 40 weight percent and about 60 weight percent of the first (meth)acrylic copolymer or stage and between about 40 weight percent and about 60 weight percent of the second (meth)acrylic copolymer or stage, based on a total weight of (meth)acrylic copolymers or stages in the latex emulsion.

59. The latex emulsion of claim 46, wherein the latex emulsion is free of multivalent metal ion complexes.

60. The latex emulsion of claim 46, further comprising an additive chosen from a dispersant, a biocide, a fungicide, an UV stabilizer, an UV absorber, a thickener, a wetting agent, a defoamer, a filler, a pigment or colorant, and combinations thereof.

61. The latex emulsion of claim 60, wherein the latex emulsion comprises less than 0.5 weight percent of a crosslinking promoting metal complex.

62. A roofing system, comprising:
a bituminous roofing material; and
a coating on a surface of the bituminous roofing material, wherein the coating is formed from a latex emulsion, comprising:
an aqueous carrier liquid; and
either:
a first (meth)acrylic copolymer or stage exhibiting a measured glass transition temperature of about −60° C. to about −5° C.; and
a second (meth)acrylic copolymer or stage exhibiting a measured glass transition temperature of about −10° C. to about 30° C.; wherein the first and second (meth)acrylic copolymers or stages comprise less than about 20 weight percent styrene, if any, based on the total weight of emulsion polymerized ethylenically unsaturated monomers in the first and second (meth)acrylic copolymers or stages; or
one or more gradient emulsion copolymers having a broad measured T_{g}, wherein the one or more gradient emulsion copolymers is a reaction product of a first (meth)acrylic monomer composition which, when polymerized, would provide a (meth)acrylic copolymer having a measured T_{g} of about −60° C. to about −5° C. and a second (meth)acrylic monomer composition which, when polymerized, would provide a copolymer having a measured T_{g} of about −10° C. to about 30° C., wherein relative proportions of the a first (meth)acrylic monomer composition and the second (meth)acrylic monomer composition changes during formation of the one or more gradient emulsion copolymers.

63. A method, comprising:
coating a bituminous roofing material with a coating formed from a latex emulsion, comprising:
an aqueous carrier liquid; and
either:
a first (meth)acrylic copolymer or stage exhibiting a measured glass transition temperature of about −60° C. to about −5° C.; and
a second (meth)acrylic copolymer or stage exhibiting a measured glass transition temperature of about −10° C. to about 30° C.; wherein the first and second (meth)acrylic copolymers or stages comprise less than about 20 weight percent styrene, if any, based on the total weight of emulsion polymerized ethylenically unsaturated monomers in the first and second (meth)acrylic copolymers or stages; or
one or more gradient emulsion copolymers having a broad measured T_{g}, wherein the one or more gradient emulsion copolymers is a reaction product of a first (meth)acrylic monomer composition which, when polymerized, would provide a (meth)acrylic copolymer having a measured T_{g} of about −60° C. to about −5° C. and a second (meth)acrylic monomer composition which, when polymerized, would provide a copolymer having a measured T_{g} of about −10° C. to about 30° C., wherein relative proportions of the a first (meth)acrylic monomer composition and the second (meth)acrylic monomer composition changes during formation of the one or more gradient emulsion copolymers.
